(19) United States
(12) Patent Application Publication
(10) Pub. No.: US 2008/0154014 A1
(43) Pub. Date: Jun. 26, 2008

(54) Transparent Polyamide Films

(75) Inventors: Ulrich Siemann, Weil am Rhein (DE); Sandra Kubler, Freiburg (DE); Sabine Eberhardt, Weil am Rhein (DE); Sascha Sedelmeier, Freiburg (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: Lofo High Tech Film GmbH, Rhein (DE)

(21) Appl. No.: 11/911,580

(22) PCT Filed: Apr. 20, 2006
(86) PCT No.: PCT/EP06/03643

§ 371 Date: Oct. 15, 2007

Related U.S. Application Data
(60) Provisional application No. 60/674,301, filed on Apr. 25, 2005.

(30) Foreign Application Priority Data
Apr. 20, 2005 (EP) 05008657.8

(51) Int. Cl. C08G 69/26; B29D 7/01

(52) U.S. Cl. 528/335; 264/216

(57) ABSTRACT

A method for producing transparent cast polyamide films from amorphous polyamides. The films are suitable for use as polarization protection films and as retardation and compensation films.

### BACKGROUND

The present invention relates to a method for producing transparent polyamide films made from amorphous polyamides. After a mono-axial or biaxial stretching the films according to the invention are provided with a negative birefringence and can then be used as retardation or compensation films in liquid crystal displays (LDS's). In order to protect sensitive polarization films made from plastics, such as for example polyvinyl acetate (PVA), they can be used unstretched as polarizer protection films.

In birefringent media, the optical transmission time of a light beam having a certain wavelength at a certain temperature is retarded by said medium in reference to the light beam in a vacuum. The retardation can also be listed as a path difference and usually ranges from 0 to 400 nm. A retardation of 280 nm is equivalent to half the wavelength in the average spectral optic range.

Liquid crystal displays have the primary disadvantage in reference to cathode ray tube (CRT) display screen that frequently the contrast is reduced when observed at an angle. The most frequently used liquid crystal displays are the so-called TN TFT-displays, with their liquid crystal cell having nematic features. In TN TFT-displays light (artificially created by background lighting or in reflective displays by an incoming dispersed light) enters the polarization layer through a polarizer in the form of (circular) non-polarized light, leaving it as a linearly polarized light. If no power is connected the liquid crystals (liquid crystal molecules) arrange horizontally inside the cell, by a first (lower) liquid crystal molecule aligning to a coupling layer located at the bottom and a second (upper) liquid crystal molecule to an upper coupling layer of the liquid crystal cell, offset by approximately 90°. By this positioning of the molecules, the incoming polarized light is rotated by 90° and then passes the second polarizer, directly facing the observer, rotated by 90° in reference to the first one. This way, the pixel located therebehind is visible as a light dot. When power is connected the liquid crystal molecules align vertically, the polarized light is no longer rotated by 90° and thus blocked by the polarizer. The pixel is no longer lit and remains black. Due to the fact that the liquid crystal molecules inside the coupling layer are never aligned completely correct and thus create an erroneous angle to a more or less extent, the incoming light is partially refracted diffusely. This reduces the contrast. The larger the difference of the observation angle from the optic axis the more effect in TN TFT-displays increases. A retardation film between the liquid crystal cell and the polarizer engages at this point and compensates the diffuse refraction of the light. This improves both the contrast as well as the maximally useful angle of observation. The respective film is then called a wide view film.

In order for the liquid crystal display to be clearly visible and have full contrast even at an obtuse angle, the retardation film for a TFT-display must be provided with a negative retardation (Rₜₕ—a so-called “minus c-plate”) in the so-called VA or MVA-mode (vertically aligned or multi-domain vertically aligned mode).

Consumers set the highest requirements with regard to optical performance for liquid crystal displays in high-price computer monitors, television sets, video cameras, digital cameras, global positioning systems, etc. By illumination these films are also exposed to a long-term thermal stress and radiation and must be provided with high transparency and stability.

For the design of compensation elements in liquid crystal displays, among other things, films made from aromatic polyesters (PC) or cycloolefin copolymers (COC) are used. PC-films have the disadvantage that they show a positive retardation and thus cannot be used as wide view films in liquid crystal displays in the VA, MVA, or IPS mode (in plane switching). COC-films are relatively expensive and not light resistant for the long term. Humidity and oxygen can diffuse into these films at an elevated temperature and lead to damage of the film itself.

### SUMMARY

The object to be attained is to provide a method for producing optic films suitable, on the one hand, as polarization protection films and, on the other hand, have negative retardation after monoaxial or biaxial stretching.

This object was attained according to claim 1.

A method is claimed to produce transparent polyamide films by applying a solution of an amorphous polyamide with a concentration of 10 to 40% by weight in an organic solvent onto a continuous carrier, selected from a group comprising a matte or polished stainless steel belt, a matte or polished stainless steel drum, for example coated with chromium or a plastic film. The solvent is evaporated until a self-sustaining film has been yielded and the film can be removed from the belt or the drum.

By combining the casting method on a continuous carrier, which itself has a defined length, for the first time by the method according to the invention optically transparent, isotropic cast polyamide films can be continuously yielded.

Transparent polyamide films for optic applications, for example made from PA12 or PA66 are usually produced by extrusion blow-casting. These films are subject to an alignment by the production process even in the unstretched condition and cannot be produced in an optically isotropic fashion. Optic cast films of polyamide solvents for LCD applications have not been known previously. Further, most polyamides show such a distinctly poor dissolution in common solvents for film production by casting, that the concentrations necessary for producing films are not reached.

From C. Renger et. al, Macromolecules 33, 2000, 8388 the use of solvents comprising “amorphous” polyamides are known for coating silicon carriers in the spin coating method. From the data it can be concluded that here only physically amorphous polyamides are used. The films yielded remain on the carrier. Data regarding their optic features are not provided.

From JP-A-2003-306560 cast polyamido-imide films are known. Pure polyamide films are not disclosed.

From JP-A-02004-149639 it is known that optic extrusion films made from various amorphous plastics having a low tendency to form crystalline structures show a particularly high transparency and a low birefringence.

In particular for producing thicker films, cast solutions are necessary with a content of solid matter exceeding 10% by weight, preferably 20% by weight. It now has been found that amorphous polyamides are suitable to produce casting solutions for the production of self-sustaining transparent optic films.

### DETAILED DESCRIPTION OF THE PREFERRED EMBODIMENTS

Cast polyamide solutions ready for use can be made from commercially available polyamide granules with different grain sizes and/or milling of amorphous polyamides with a content of solid matter ranging from 10 to 35% by weight. They are stable for storage and can be used to produce polyamide films. Furthermore, it has been found that the transparent cast polyamide films yielded this method are provided with a particularly strong negative birefringence after the biaxial stretching. The cast polyamide films are suitable as protective polarization, retardation, and compensation films in liquid crystal displays.

The term cast polyamide film particularly relates to films that can be yielded from polyamides according to the following definition in a solvent casting method.

The term amorphous polyamide in the sense of the method according to the invention relates to polyamides largely prevented by suitable structural elements in the polymer, i.e. by their chemical structure, from forming crystalline sections or domains during the slow evaporation of solvents or when the melt cools. Amorphous polyamides are used for injection molding processes, extrusion, blow-extrusion, and cast injection methods from melts, e.g., for producing decorative bodies, and are commercially available.

The term amorphous polyamide in the sense of the invention therefore does not relate to any “physically amorphous” polyamides that can only be yielded by the rapid removal of the solvent, for example by spray drying or by quenching the melt, at least temporarily being held in an amorphous state, but which can form crystalline domains, e.g., when being tempered.

Generally crystalline or partially crystalline domains in polymers do not comprise individual, large crystals but are provided with a higher density of small and minute crystallites as the surrounding areas. The presence of crystalline or partially crystalline domains can for example be proven by interference microscopy or by determining the refraction of light (Rayleigh refraction). The presence of such domains can be measured above a domain size of approx. 1/20 of the wavelength of the incoming light. All testing methods and definitions possible here relate to crystals, partially crystalline sections etc. that can be detected in the optic wavelengths ranging from 800 to 400 nm and/or have an influence on the optic features of films in this range.

Partially crystalline domains are provided, among other things, with different refraction features than their surrounding matrix and negatively influence liquid crystal displays. The cast polyamide films that can be produced according to the method of the invention include no visible partially crystalline sections, internal stress, or other inhomogeneities, with their lateral extension in the direction of view (perpendicular in reference to the surface of the film) being larger than 50 nm, preferably no larger than 35 nm, and particularly preferred no larger than 20 nm. Overall, the portion of the crystalline range may not exceed 10% by volume, preferably no more than 7% by volume, particularly no more than 5% by volume.

In a preferred method the amorphous polyamide contains structural elements developing by the inclusion of a) at least one bulky diamine or one derivative thereof suitable for poly-condensation, b) at least one bulky dicarboxylic acid or a derivative thereof suitable for poly-condensation, as well as c) at least one lactam with at least 10 carbon atoms, or an open chained derivative thereof suitable for poly-condensation. Bulky diamines relate to diamines in which particularly the mobility and rotation between the two amino groups is hindered by steric effects, such as for example asymmetrically substituted rings or (voluminous) secondary groups. Of course, an amorphous polyamide may also contain short-chained lactams in addition to a lactam with at least 10 carbon atoms. However, they increase water absorption and crystallinity.

In another preferred method the amorphous polyamide comprises at least the structural elements of the formulas

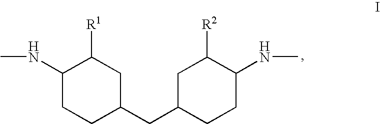

in which R¹ and R² represent hydrogen or a C₁₋₄-alkyl group independent from each other,

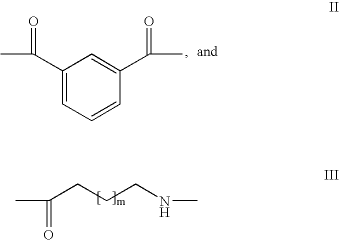

in which m represents a number from 7 to 11.

In a particularly preferred embodiment R¹ and R² are hydrogen, methyl, or ethyl, independent from each other.

In another particular embodiment variant m has the value 8 or 9.

The structural elements of the formula I are deducted from the alkyl substituted bi-(amino)-cyclo-alkanes with 15 to 21 C-atoms, in which R¹ and R² represent hydrogen or C₁₋₄-alkyl, independent from each other, preferably bi(3-methyl-4-aminocyclohexyl)-methane.

Here and in the following, C₁₋ₙ-alkyl represents an alkyl group with 1 to n carbon atoms. In particular, C₁₋₄-alkyl represents methyl, ethyl, propyl, or butyl.

The structural elements of the formula III are deducted from the unbranched aliphatic c)-amino carboxylic/acids with 10 to 14 C-atoms and/or their lactams, preferably of ω-amino undecanoic acid or ω-amino dodecanoic acid and/or their lactams. The structural elements of the formula III can also be connected to themselves. Such polymers can also be used as a blend.

In a preferred embodiment the amorphous polyamide is a co-polyamide, i.e. a co-polymer, which does not comprise the respectively mentioned structural elements in a pure form. Depending on the conditions of polycondensation the co-polymers may be provided, for example, as block polymers or grafted polymers.

In another preferred embodiment, the amorphous polyamide is a blend or an alloy comprising at least two polyamides, having at least one amorphous polyamide, at least having structural elements of the formula I and II, with R¹ and R² being defined as described above. At least one component of the blend must comprise structural elements of the formula III, with m being defined as above.

A polyamide blend may also comprise a co-polyamide, of course. Conditional is only that the resulting amorphous polyamide or polyamide blend, as explained in greater detail in the following, can be dissolved in cast polyamide solutions in an amount ranging from 10 to 40% by weight solid matter and yield a transparent film after processing.

In order to further limit the formation of partially crystalline sections the amorphous polyamide may include at least another structural element,

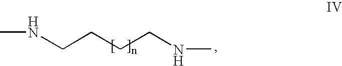

in which n represents a number from 3 to 11, and/or

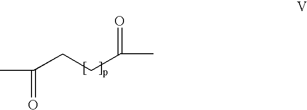

in which p represents a number from 3 to 11.

In another preferred embodiment variant n and p independently represent the value 8 or 9.

The structural elements of the formula IV are deduced from the unbranched aliphatic diamines with 10 to 14 C-atoms, preferably from undecanodiamine or dodecanodiamine.

Polyamides sometimes swell to quite a large degree dependent upon the water absorption. In particular in optic films, this is very disadvantageous due to the change in shape connected thereto. Additionally, in liquid crystal screens, in case of a large absorption of moisture, water can penetrate to the polarization film or into the liquid crystal cell and damage it there. This can be prevented by the polarity of the polyamide film being kept as low as possible by a suitable selection of the structural elements included in the amorphous polyamide. A low polarity correlates to a low tendency to absorb water. In the structural elements of the monomers, in particular the number of hetero-atoms and polar groups shall be kept as low as possible in reference to the number of structural carbon atoms. For example, lauric lactam is preferred as a monomer in reference to caprolactam. In particular the use of polyether structures, for example by implementing tetra-hydrofurane or the modification of amino-end groups with polypropylene glycols the absorption capacity for water is facilitated.

In a preferred embodiment the components of the formula I in reference to the components of the formula IV are at a ratio of 1:0 to 1:9, particularly preferred above 1:0.1. Additionally, the components of the formula II can show a ratio of 1:0 to 1:9 in reference to the components of the formula V, particularly preferred above 1:0.1.

In a preferred embodiment the amorphous polyamide contains structural elements of the formula I, II, and III, in which R¹ and R² each represent hydrogen, methyl, or ethyl independent from each other and m has the value 8 or 9.

Particularly preferred the amorphous polyamide comprises structural elements of the formulas I, II, and III, in which R¹ and R² each represent methyl and m has the value 8 or 9.

Particularly suitable amorphous polyamides have a glass transition temperature ranging from 110 to 210° C. and a density ranging from 1.0 to 2.0 g/cm³, preferably from 1.0 to 1.06 g/cm³.

Particularly suitable are, among others, the amorphous and transparent polyamides disclosed in EP-A-725101 and EP-A-848034, which for example can be supplied by the company EMS—Chemie under the name Grilamid TR 55 and/or TR 90. The qualities of Grilamid TR 55, yielded from bi(3-methyl-4-aminocyclohexyl)-methane, isophthalic acid, and ω-amino-dodecanoic acid and/or its lactams are particularly preferred.

Cast polyamide solutions made from amorphous polyamide comprise a portion of solid matter in the amount of at least 10% by weight, preferably at an amount ranging from 15 to 35% by weight, and particularly preferred in an amount ranging from 20 to 24% by weight. Above a solid matter content of 50% by weight usually no solvent castable polyamide solutions are yielded. Particularly proven are solvent cast polyamide solutions with at least a 20% by weight content of solid matter.

Amorphous polyamide of the composition described here is a melt extrusion injection molding material and has previously not been used for producing films. In general, extruded polyamide films have such a high and inhomogeneous retardation value that they are not suitable for the production of retardation films. This is discernible from the reference examples 1 and 2.

In a preferred embodiment of the method, the solvent comprises at least one compound selected from a group comprising C₁₋₄-alcohols, CHCl₃, CH₂Cl₂, one-core aromatic compounds with 6-10 carbon atoms, one-core heterocyclic compounds with 3 to 10 carbon atoms, and mixtures thereof.

Additionally, compounds of the group comprising dimethyl-sulphoxide (DMSO), N,N-dimethyl-acetamide (DMAc), morpholine, dioxane, and furane can be added as solubilizers.

Preferably the C₁₋₄-alcohol is selected from a group comprising methanol, ethanol, propanol, isopropyl alcohol, n-butanol, and tert-butanol.

One-core aromatic compounds with 6 to 10 carbon atoms in the sense of the invention comprise a benzene ring, perhaps one or more substituents selected from the group comprising halogen, C₁₋₄-alkyl, and C₁₋₄-alkoxy. Examples for one and two-core aromatic compounds with 6 to 10 carbon atoms are toluene, xylene, or anisole.

Here and in the following, C₁₋₄-alkoxy represents an alkoxy group with 1 to n carbon atoms. In particular, C₁₋₄ alkoxy represents methoxy, ethoxy, propoxy, and butyloxy.

One-core aromatic heterocyclic compounds with 3 to 10 carbon atoms in the sense of the invention comprise at least one or more N-, O- or S-hetero atoms and also one or more substituents, selected from a group comprising halogen, C₁₋₄-alkyl, C₁₋₄-alkoxy. Examples for the mentioned heterocyclic compounds are morpholines, tetrahydrofuranes, dioxanes, thiolanes, furanes, or imidazols or N-methyl-2-pyrrolidones (NMP.)

Particularly preferred is the solvent selected from the group comprising C₁₋₄-alcohols, CHCl₃, CH₂Cl₂, toluene, xylene, and mixtures thereof.

Preferably the solvent of the cast solution comprises methylene chloride and at least one C₁₋₄-alcohol at a weight ratio CH₂Cl₂/alcohol of 50:50 to 80:20. It is particularly preferred to use methanol or ethanol as alcohols. If necessary, the solvent mixture additionally comprises solubilizers with an overall portion by weight of no more than 10% by weight, such as for example dioxane, THF, or dimethyl sulphoxide.

In a preferred embodiment cast polyamide solutions and the films made therefrom comprise additives, such as plasticizers, colorants, UV-absorbers, or releasing agents.

Suitable plasticizers are, for example, triphenyl-phosphate, which can be included in the finished film in an amount of up to 10% in reference to the polymer portion.

Suitable colorants are all colorants which dissolve in the solvents mentioned for the production of cast polyamide solutions such that the solution remains transparent. Preferably the cast solutions include colorants in an amount ranging from 0.001 to 2%, preferably in an amount of 0.001 to 0.05%.

The addition of releasing agents to the cast solutions allows a better separation of the cast film off the support. Suitable releasing agents are, for example, non-ionic polyol-tensides and can be selected from a group comprising poly(ethylene glycol), poly(propylene glycol), and poly(tetramethylene oxide). Preferably they are used as homopolymers, copolymers, and/or block copolymers. Particularly preferred, a polyethylene polypropylene block copolymer is used. Particularly suitable are “Pluronic® PE 6800” or “Synperonic® F86 pract.”. Preferably the cast solutions include releasing agents in an amount of 0.01 to 2%, preferably in an amount of 0.01 to 0.4% in a dissolved form.

Preferably the support for the film production in the solvent casting process relates to a continuous carrier. In a preferred method the continuous carrier, onto which the cast polyamide solution is applied, is selected from a group comprising a polished or matte steel belt, a polished or matte stainless steel drum, for example coated with chromium, and a plastic film.

Common film casting belts made from stainless steel or plastic have a length of up to 100 m and a width of up to 3 m. Common stainless steel drums for producing cast films have a diameter of 1 to 3 m.

In addition to application directly onto the continuous carrier, the cast film can also be applied to an intermediate film serving as a casting base. After the formation of the film of the polyamide film it can be pulled off the carrier without any intermediate film. When the intermediate film remains on the polyamide film it serves as a protection film for the surface until the next processing step is carried out, however, it is of no influence on the strength of the polyamide film according to the invention. Carriers used may be, for example, a continuous stainless steel belt, a drum, or another plastic film having sufficient supportive strength. Each of the possible combinations of intermediate film and carrier are also called continuous carriers in their entirety.

Preferably a continuous stainless steel belt is used as the carrier of an intermediate film. In a preferred embodiment a film made from polyethylene terephthalate (PET) is used as the intermediate film.

In a preferred variant embodiment the cast polyamide solution is applied on a continuous carrier and after a preliminary drying time, if necessary together with an intermediate film, pulled off said continuous carrier. Particularly preferred the further removal of the solvents and the drying of the film to the desired solvent content occurs after the removal of the cast polyamide film from the continuous carrier.

Depending on the support, the cast polyamide film is applied and the polyamide film can be yielded in the method according to the invention a) as a self-supporting film, b) as a long-term lamination on an intermediate film, or c) as a self-supporting film, which is temporarily laminated to an intermediate film that can be pulled off. It is particularly preferred to produce self-supporting polyamide films.

In a preferred method, the finally dried cast polyamide films have a thickness ranging from 10 to 400 μm. Particularly preferred are cast polyamide films with a thickness ranging from 20 to 200 μm.

Polyamide films made in the method according to the invention can additionally be coated by applying a solution or by lamination. This may for example occur to improve the optic features or to reinforce the film. The coating can also occur to protect the surface and to be removed again at a later time.

In the particular case in which a continuous cast polyamide film is connected without stretching to at least one additional film or glass pane, the finally dried films have a thickness of at least 40 μm, preferably ranging from 60 to 190 μm.

Transparent polyamide films are another object of the invention, yielded from cast polyamide solutions according to the above-mentioned method, which have a negative birefringence after monoaxial or biaxial stretching. The retardation (optic delay) is simply equivalent to the term (n₁-n₂) film thickness, with (n₁-n₂) being the difference between two refractive numbers. Two statements regarding retardation are distinguished: R₀ and Rₜₕ, with R₀ being the “in plane retardation” and Rₜₕ the “out of plane” retardation. The “in plane retardation” is the retardation perpendicular in reference to the film surface, with the “out of plane” retardation Rₜₕ according to definition extending along the optic axis within the film. Particularly in thin films, this value is not amenable to a direct measurement.

In a preferred embodiment, the finally dried cast polyamide film has, prior to stretching, retardation values R₀ in the proximity of ±0 nm. Rₜₕ-values prior to stretching range from 30 to 60 nm. R₀-values are generally only provided as an amount. In particular in mono-axially stretched films the arithmetic sign of R₀ changes when the film is rotated by 90°. In order to draw conclusions from the amount of Rₜₕ to yield additional information, such as for example the orientation of the refraction indices in the space, the arithmetic sign can be taken from the following simplified formula:

$$\begin{matrix}{R}_{0 , a \text{-} plate} = ( \vert {n}_{x} - {n}_{y} \vert ) \cdot thickness \\ {R}_{th , c \text{-} plate} = ( \frac{{n}_{x} + {n}_{y}}{2} - {n}_{z} ) \cdot thickness\end{matrix}$$

In the polyamide film according to the invention made from amorphous polyamide, after a mono-axial stretching, a so-called “a-plate” develops, at a biaxial stretching a so-called “c-plate”. For Rₜₕ in a c-plate, an average is determined from the refraction indices nₓ and n_{y}, in order to become independent from the alignment of the film in the film level.

In another preferred embodiment the amounts for retardation values Rₜₕ for cast polyamide films after the stretching range from 50 to 250 nm, preferably from 50 to 180 nm, particularly preferred from 80 to 150 nm. The amounts of R₀ values in stretched cast polyamide films preferably range from 0 to 130 nm, preferred from 15 to 100 nm, particularly preferred from 30 to 50 nm.

The measurement and calculation of the refraction indices nₓ, n_{y}, and n_{z} can for example be determined for compensation films with a negative birefringence and optical axis in the z-direction from the respective retardation values using the following formulas, with the indices x, y, and z representing the spatial refraction number in the Cartesian coordinate system.

VBR: vertical birefringence in film level

IBR: (in plane) birefringence perpendicular to film level

R₀: in plane retardation, retardation perpendicular to the film level in nm

Rφ: angular retardation in nm measured at a certain angle

Rₜₕ: retardation in film level in nm

φ_{c}: angle of incidence in retardation measurements, e.g., 45°

φ_{d}: corrected angle of incidence

d: thickness of the sample in μm

n: refractive index (if necessary with index of direction x, y, or z)

$$\begin{matrix}{R}_{m} = ( VBR + \frac{IBR}{2} ) \cdot d , applies when {n}_{y} > {n}_{x} >> {n}_{z} \\ VBR = \frac{[ {R}_{0} - R φ \cdot cos ( {φ}_{c} \cdot \frac{π}{180} ) ]}{d \cdot 1000 \cdot sin ( {φ}_{c} \cdot \frac{π}{180} ) \cdot sin ( {φ}_{c} \cdot \frac{π}{180} )} \\ IBR = \frac{{R}_{0}}{d \cdot 1000} \\ {φ}_{c} = arc sin [ \frac{sin ( \frac{φ π}{180} )}{n} ] \cdot \frac{180}{π}\end{matrix}$$

Particularly preferred are compensation or retardation films with a negative birefringence suitable for the use in liquid crystal displays, yielded by monoaxial or biaxial stretching of cast polyamide films, which were produced according to the above-mentioned method. In a mono-axial stretching an a-plate is yielded, in a bi-axial stretching a c-plate. For the use as a polarization protection film the cast polyamide films according to the invention are preferably used unstretched.

The monoaxial or biaxial stretching of the films according to the invention occurs preferably at temperatures ranging from 110 to 240° C., preferably 115 to 170° C. with stretching levels of 1:1.05 to 1:6. Particularly preferred the stretching occurs close to glass transition temperature, particularly preferred slightly above glass transition temperature. The temperatures listed for stretching relate here to the temperatures measured in the arrangement and not the actual temperature of the surface of the film to be stretched, because it cannot be directly determined at the traveling speeds used for stretching.

The invention is explained in greater detail using the following examples without being limited thereto.

Description of the Method:

a) General Condition to Produce a Cast Polyamide Solution

15 to 40% by weight of the solid polyamide (granular or powdered) is mixed in a solvent mixture of methylene chloride and at least one C₁₋₄-alcohol at a ratio CH₂Cl₂/alcohol ranging from 50:50 to 70:30 w:w). The production of the solution occurs at room temperature by way of agitation for at least 2 hours with an anchor mixer or by way of rotation and/or shaking for at least 24 hours. If necessary, additional adjuvants can be added, such as solubilizers, plasticizers, colorants, and releasing agents (for example tensides).

b) General Regulation for Producing a Cast Polyamide Film

Subsequently the cast solution is applied via a suitable caster or a doctor blade on a carrier, for example made from glass, plastic, or metal and removed from said carrier after a preliminary drying time and then finally dried to the desired residual concentration of solvents.

c) General Regulation for Stretching the Cast Film

For producing the stretched films the finally dehydrated films are stretched monoaxially or biaxially at a temperature ranging from 110 to 240° C., preferably from 150 to 190° C., particularly preferred from 160 to 170° C. Preferred stretching levels can range from 1:1.05 to 1:6.

The polyamides yielded in the examples have a glass transfer temperature (T_{g}) of approximately 161° C.

### Example 1

For the production of a polyamide solution methylene chloride and methanol are used as solvents at a ratio by weight of 6:4 (w:w). The solvent mixture is heated in the water bath to 50° C. using a reflux cooler and agitated with a horseshoe mixer at 150 rpm. The releasing agent is added at a concentration of 0.1% by weight (calculated in reference to the total solid matter). Subsequently, during constant agitation, slowly 25% by weight polyamide granules (Grilamid TR 55, available from the company EMS Chemie AG/Switzerland) is added to the mixture of solvents. The mixture is agitated for 4 hours at 50° C. with a reflux cooler until the polyamide is entirely dissolved and a highly viscose clear liquid is given.

After the solution has cooled to room temperature a transparent film of 80 μm is produced, glossy at both sides. For this purpose, the polyamide solution is filled into a 20 cm wide film doctor with a gap of 410 μm and applied onto a carrier at 12 mm/s. The film is then dried at room temperature for 5 minutes and then drying continues for another 30 minutes at 80° C. and subsequently separated from the support.

### Example 2

15 to 40% by weight of the solid polyamide (Grilamid TR 55, as granules or powder) is mixed with a solvent mixture comprising methylene chloride/methanol and is agitated at room temperature with an anchor mixer (at least for 2 hours) or by way of rolling and/or shaking (at least for 24 hours). The casting solution is poured onto the surface using a doctor blade and preliminarily dried for 20 minutes at room temperature. The final dehydration occurs at 80° C. for 1 to 24 hours. The films yielded have a thickness of 10 to 400 nm. After the removal from the support the film is stretched monoaxially at 170° C., using stretching ratios ranging from 1:1.05 to 1:6.

TABLE 1
Retardation determination R₀ of unstretched cast
polyamide films according to examples 1 and 2

| | Thickness of | Thickness of | Thickness of | Thickness of |
|---|---|---|---|---|
| | film 100 μm | film 94 μm | film 102 μm | film 98 μm |
| Angle of | Retardation | Retardation | Retardation | Retardation |
| incidence [°] | [nm] | [nm] | [nm] | [nm] |
| −50 | 44 | 84 | 84 | 81 |
| −40 | 30 | 57 | 58 | 84 |
| −30 | 18 | 34 | 33 | 32 |
| −20 | 9 | 16 | 16 | 15 |
| −10 | 3 | 5 | 4 | 4 |
| 0 | 1 | 1 | 0 | 0 |
| 10 | 2 | 4 | 3 | 3 |
| 20 | 7 | 13 | 13 | 13 |
| 30 | 15 | 29 | 30 | 29 |
| 40 | 26 | 51 | 53 | 51 |
| 50 | 39 | 77 | 81 | 77 |

The measurements occurred at 25° C. and lightwaves of lengths 632.8 nm with the “birefringence measurement system” Exicor 150 AT of the company Hinds, D-80992 Munich.

### Examples 3-6

According to the examples 1 and 2 films with thicknesses amounting to 81 μm, 99 μm, and 87 μm were produced.

TABLE 2
Retardation determination of cast polyamide films
made from Grilamid 55 of the examples 3-6.

| Example/Stretching | | Retardation at 0° [nm] | Rₜₕ [nm] |
|---|---|---|---|
| 3 | 81 μm unstretched | 1 | −47 |
| 4 | 99 μm → 92 μm | 53 | −66 |
| 5 | 96 μm → 93 μm | 43 | −62 |
| 6 | 87 μm→ 71 μm | 9 | −142 |

The measurements of table 2 were also yielded at 25° C. and 632.8 nm.

### Example 7-14

Using Grilamid TR 55, (films) were produced on a film casting machine [location Weil am Rhein, DE] with an average thickness of 42 (41-44), 82 μm (80-86 μm) and 101 μm (98-105 μm). For the industrial production on the casting machine the casting solution is applied onto a polished stainless steel belt. After being pulled off the support, the casting film passes on rollers a more or less extended drying chamber and shall be examined at the end of the drying chamber for residual moisture and material thickness. Any potentially necessary secondary drying commonly occurs in a separate drying chamber. At the beginning of the drying chamber the film is pulled off the support sheath and passes through a heated roller arrangement, in order to be again wound onto the carrier sheath or a similar device at the end of the secondary dehydration.

The solvent mixture used, CH₂Cl₂/MeOH (60:40, w:w), is to be of such low boiling point that no later than the first drying chamber the solvent is largely removed. The films with a thickness of 82 and 101 μm were measured and evaluated prior (GT) and after (NT) the secondary dehydration. The thickness of the films after the secondary dehydration only reduced slightly, if at all. In the films with 42 μm thickness, based on the low material thickness no secondary dehydration was necessary to remove any solvent residue. The casting belt was adjusted to a temperature of approximately 25 to 50° C., the drying chamber following the casting machine to approximately 70° C. In the secondarily dehydrated films the roll was dried in a separate drying arrangement for approximately 40 minutes at a temperature of approximately 85° C. and a traveling speed of approximately 2 m/min.

TABLE 3
Features of cast polyamide films made
from Grilamid 55 of the example 7-14

| | Thickness | Thickness | Turbidness | Turbidness |
|---|---|---|---|---|
| Example | GM [μm] | NT [μm] | GM [%] | NT [%] |
| 7 | 41-44 | n.a. | 0.09-0.13 | n.a. |
| 8 | 41-44 | n.a. | 0.08-0.15 | n.a. |
| 9 | 41-45 | n.a. | 0.06-0.14 | n.a. |
| 10 | 41-45 | n.a. | 0.06-0.13 | n.a. |
| 11 | 80-86 | 79-85 | 0.08-0.12 | 0.20-0.25 |
| 13 | 98-105 | 96-104 | 0.10-0.18 | 0.11-0.24 |
| 14 | 98-105 | 98-105 | n.a. | 0.09-0.25 |

n.a. - no values available

The retardation values R₀ and Rₜₕ as well as the residual solvent values (RLM) of unstretched films of the examples 7, 8, 9, 10 11, 12, and 13 are shown in Table 4.

TABLE 4
Features of cast polyamide films made
from Grilamid 55 of the examples 7-14

| | | R₀/Rₜₕ NT | | |
|---|---|---|---|---|
| Example | R₀/Rₜₕ GM | [nm] | RLM GM [%] | RLM NT [%] |
| 7 | 1.8/38 | n.a. | 0.81 | n.a. |
| 8 | 1.7/38 | n.a. | 1.19 | n.a. |
| 9 | 1.1/33 | n.a. | 1.01 | n.a. |
| 10 | 0.9/30 | n.a. | 1.09 | n.a. |
| 11 | n.a. | 8.0/45 | n.a. | 0.40 |
| 12 | n.a. | n.a. | n.a. | 1.24 |
| 13 | n.a. | 6.0/49 | n.a. | 0.94 |

A film according to example 1 with a thickness averaging 82 μm was stretched on an industrial stretching machine with a speed of 100 mm/min at a temperature of 160 and/or 162° C., using stretching levels ranges from 1.1 to 1.6. The retardation values R₀ and Rₜₕ at various stretching levels are shown in tables 5 and 6. The unstretched film is equivalent to a stretching level of 1.

TABLE 5
Features of a stretched cast polyamide film of example 11

| Stretching level | R_{0, 160° C.} | R_{0, 162° C.} |
|---|---|---|
| 1 | 3 | 3 |
| 1.1 | 142 | 129 |
| 1.2 | 249 | 234 |
| 1.3 | 335 | 299 |
| 1.4 | 444 | 414 |
| 1.5 | 530 | 457 |
| 1.6 | 578 | 489 |

TABLE 6
Features of a stretched cast polyamide film of example 11

| Stretching level | R_{0, 160° C.} | R_{0, 162° C.} |
|---|---|---|
| 1 | 40 | 40 |
| 1.1 | 98 | 78 |
| 1.2 | 146 | 134 |
| 1.3 | 189 | 167 |
| 1.4 | 268 | 218 |
| 1.5 | 278 | 342 |
| 1.6 | 305 | 249 |

### Example 15

From a film stretched to 50 μm of example 11 (stretching level ˜1.2, at T=160° C.) a multi-layered film stack was prepared, as used for example in flat screen. The finished stack comprises the layers TAC, PVA, PC a-plate, PA-films according to the invention, liquid crystal cells, TAC, PVA, and TAC (TAC=triacetyl cellulose, PVA—polyvinyl acetate, PC a-plate=polycarbonate a-plate). In the bi-axially stretched polyamide film according to the invention used for the designed screens the values R₀ could be determined as approximately 60 nm and Rₜₕ as approximately 180 nm. In a Cartesian coordinate system, using an Azimut angle of 90 to 400, a contrast ratio >100 could be determined with an almost circular symmetry.

### Reference Examples 1 and 2

From amorphous Grilamid TR 55, in a conventional method, films with a thickness of approximately 300 μm were extruded and R₀ and Rₜₕ were determined. Thinner films could not be produced due to the high melted viscosity of Grilamid TR 55. The results are shown in table 7.

TABLE 7
Features of extruded films of the reference examples 1 and 2:

| | R₀ | Rₜₕ |
|---|---|---|
| Extrusion pattern 1 | 121 ± 100 | 269 ± 526 |
| Extrusion pattern 2 | 221 ± 82 | −15 ± 411 |
| Pattern 1/2: | Haze: | 4-5% |
| | Profile: | Not measurable |
| | Thickness: | 308-334 μm |
| | Visual evaluation: | Gel particles at the |
| | | surface worse than in |
| | | cast films. |
| | | Thickness lines/ |
| | | thickness variation |
| | | (casting lines/lines in |
| | | general) are considerably |
| | | worse than in cast films. |

1. A method for producing transparent films made from amorphous polyamide by applying cast solutions, at least comprising 10 to 40% by weight of an amorphous polyamide in an organic solvent, to a continuous carrier, which is selected from a group comprising a matte or polished stainless steel belt, a matte or polished stainless steel drum, from which the polyamide film is pulled off after evaporation of a solvent to yield a self-supporting film.

2. A method according to claim 1, wherein the amorphous polyamide includes at least structural elements of the formulas 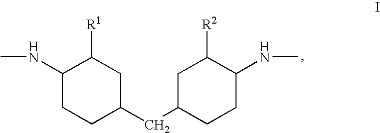
in which R¹ and R² represent, independent from each other, hydrogen or a C₁₋₄-alkyl group, comprising 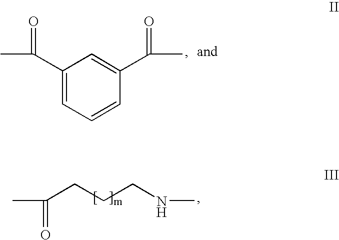
with m representing a number ranging from 7 to 11.

3. A method according claim 1, wherein R¹ and R², independent from each other, represent hydrogen, methyl, or ethyl.

4. A method according to claim 1, wherein the amorphous polyamide is a copolyamide.

5. A method according to claim 1, wherein the amorphous polyamide is a blend or an alloy comprising at least two polyamides.

6. A method according to claim 1, wherein the amorphous polyamide comprises at least one additional structural element 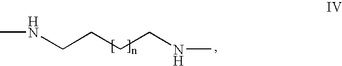
in which n represents a number ranging from 7 to 11, or 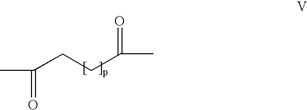
in which p represents a number ranging from 7 to 11.

7. A method according to claim 1, wherein the organic solvent comprises a compound, selected from a group consisting of C₁₋₄-alcohols, N,N-dimethyl formamide, N,N-dimethyl acetamide, dimethyl sulphoxide, one-core aromatic compounds with 6 to 10 carbon atoms, one-core heterocyclic compounds with 3 to 10 carbon atoms, and mixtures thereof.

8. A method according to claim 7, wherein the C₁₋₄-alcohol represents methanol, ethanol, propanol, isopropyl alcohol, n-butanol, or tert-butanol.

9. A method according to claim 1, wherein the organic solvent is selected from a group consisting of N,N-dimethyl formamide, N,N-dimethyl acetamide, methanol, ethanol, dimethyl sulphoxide, CHCl₃, CH₂Cl₂, morpholine, dioxane, furane, toluene, xylene, N-methyl-2-pyrrolidone, (NMP), and mixtures thereof.

10. A method according to claim 1, wherein the continuous carrier is selected from a group consisting of the polished or matte steel belt, the polished or matte stainless steel drum, or a plastic film.

11. A method according to claim 1, wherein the polyamide cast solution is applied onto the continuous carrier using a separately fed intermediate film and the self-supporting polyamide film is pulled off said continuous carrier after a preliminary drying term together with the intermediate film.

12. A method according to claim 11, wherein the finally dried polyamide cast film has a thickness ranging from 10 to 400 μm.

13. The method of claim 1, further comprising monoaxial or biaxial stretching of the polyamide film to provide the polyamide film with a negative birefringence.

14. The method according to claim 13, wherein the monoaxial or biaxial stretching is performed at temperatures ranging from 110 to 240° C., with stretching levels ranging from 1:1.05 to 1:6.

15. The method of claim 1, further comprising applying the polyamide film as compensator or retardation films in liquid crystal displays.

16. The method according to claim 1, further comprising applying the polyamide film in an unstretched condition, as a protective polarization film in liquid crystal displays.

17. A transparent polyamide cast film produced by the method according to claim 1.

18. A transparent polyamide cast film produced by the method according to claim 13.
